(19) United States
(12) Patent Application Publication
(10) Pub. No.: US 2015/0230484 A1
(43) Pub. Date: Aug. 20, 2015

(54) Lactose-Free Milk Products

(71) Applicant: DMK Deutsches Milchkontor GmbH, Zeven (DE)

(72) Inventor: Sven-Rainer Döring, Zeven (DE)

(21) Appl. No.: 14/621,974

(22) Filed: Feb. 13, 2015

(30) Foreign Application Priority Data
Feb. 17, 2014 (EP) 14 155 481.6

(51) Int. Cl. A23C 9/12

(52) U.S. Cl. CPC A23C 9/1206

(57) ABSTRACT

A process for producing lactose-free milk products is proposed in which
(a) skimmed milk is subjected to an ultrafiltration or to a combination of dia- and ultrafiltration,
(b) the lactose-free retentate R1 is fed to a storage container and the lactose-containing permeate P1 is fed to an enzyme reactor,
(c) an amount of lactase sufficient for the enzymatic degradation of the lactose present therein is added to the permeate P1,
(d) the reaction mixture obtained in this way is subjected to a nanofiltration,
(e) the lactose-free permeate P2 is conveyed to the storage container and mixed with the lactose-free retentate R2, and
(f) the retentate R2, which still comprises unreacted lactose and enzyme, is returned again to the enzyme reactor.

### FIELD OF THE INVENTION

The invention is in the field of the milk industry and relates to a new process for producing low-lactose or lactose-free products, and a corresponding device.

### PRIOR ART

During their lactation period, newborn mammals form the enzyme lactase, which cleaves the disaccharide lactose into the sugar types D-galactose and D-glucose which can be utilized by the metabolism. In the course of natural weaning from the mother's milk, the activity of the lactase drops to about 5-10% of the activity at birth. This is true for humans and for all other mammals. Only in populations which have operated dairy farming for a long time has a mutation evolved which leads to sufficient lactase still being produced in adulthood (lactase persistence). This is presumably because the higher lactase activity offered a selection advantage (minerals, nutritional value) for these groups.

In the event of inadequate lactase activity, uncleaved lactose travels in humans to the large intestine where it is absorbed and fermented by intestinal bacteria. Lactic acid and also methane and hydrogen are formed as fermentation products. The gases lead inter alia to flatulence, the osmotically active lactic acid leads to water being drawn into the intestine (osmotic diarrhea).

In Asia and Africa, the lack of lactase persistence or lactose intolerance affects the majority of the adult population (90% or more), in Western Europe, Australia and North America it is 5-15% (in pale-skinned people). In Germany, according to estimates, 15-25% of the total population suffer from lactose intolerance. The reason for lactose intolerance is a congenital enzyme deficiency in which the corresponding enzymes are missing which cleave and degrade the lactose into its individual constituents. In recent years, at least the awareness of the connection between the specified symptoms and the presence of lactose particularly in milk products has greatly increased. This has led to there being a great need for low-lactose or better still lactose-free products.

A very wide variety of processes are known from the prior art, with the help of which lactose can either be removed from milk products and be further processed as a by-product, or can be degraded by adding corresponding enzymes.

For example, EP 0208706 A1 (VALIO) describes the removal of lactose from skimmed milk by ultrafiltration.

The subject matter of EP 226035 A1 (VALIO) is a process in which the lactose is removed chromatographically from the milk with the help of cation exchangers.

In WO 2008 000895 A1 (VALIO) proposes treating milk with lactase and in so doing partially hydrolysing it, then deactivating the enzyme by thermal treatment and, finally, destroying unreacted lactose by acidification.

A further process is known from EP 1503630 B1 (VALIO): In this, milk is subjected to an ultrafiltration, the obtained permeate is nanofiltered, the permeate resulting therefrom is concentrated by reverse osmosis and then treated with lactase. After an adequate residence time, the low-lactose product is combined with the retentate and further processed.

A common problem of the processes of the prior art, however, consists in the long retention times which are required in order to ensure as complete as possible a degradation of the lactose, and also the fact that the enzymes remain in the product.

The object of the present invention was therefore to provide a process for producing lactose-free milk products which reliably overcomes the described disadvantages of the prior art and in particular allows lactose-free milk products to be provided in a considerably shortened reaction time which, moreover, also no longer contain enzymes.

### DESCRIPTION OF THE INVENTION

The subject matter of the invention is a process for producing lactose-free milk products in which
(a) skimmed milk is subjected to an ultrafiltration or to a combination of dia- and ultrafiltration,
(b) the lactose-free retentate R1 is fed to a storage container and the lactose-containing permeate P1 is fed to an enzyme reactor,
(c) an amount of lactase sufficient for the enzymatic degradation of the lactose present therein is added to the permeate P1,
(d) the reaction mixture obtained in this way is subjected to a nanofiltration,
(e) the lactose-free permeate P2 is conveyed to the storage container and mixed with the lactose-free retentate R2 and
(f) the retentate R2, which still comprises unreacted lactose and enzyme, is returned again to the enzyme reactor.

Surprisingly, it has been found that with the help of the described measures, specifically the returning of unreacted lactose and enzyme, the throughput of milk for producing the lactose-free products is significantly increased. The procedure is designed such that not only is a discontinuous operation possible, but in particular also a continuous operation. The products are lactose-free or essentially lactose-free, i.e. the fraction of lactose is less than 0.1% by weight. Moreover, no enzymes or enzyme degradation products are found in the end products. This means conversely, also again that no active enzyme is lost. In the enzyme reactor, only the amount of enzyme has to be replaced which is actually deactivated. It is obvious that the profitability of the process is considerably increased as a result of these measures.

### BRIEF DESCRIPTION OF THE DRAWING

The present invention will be described in greater detail with reference to the accompanying drawing which schematically illustrates a flow diagram for the process and device in accordance with the present invention.

### FILTRATION PROCESS

The first process step consists in subjecting the skimmed milk to an ultrafiltration or to a combination of dia- and ultrafiltration and separating it into a permeate P1 and a retentate R1. The permeate P1 contains the lactose and is treated in an enzyme reactor with lactase. The reaction mixture here is circulated over a nanofiltration device in which the lactose-free permeate P2 is removed from the system and the retentate R2 containing still unreacted lactose as well as lactase is returned to the reactor. The core element of the process according to the invention is therefore filtration steps with membranes of differing degrees of separation.

Ultra- and nanofiltration are filtration processes from the field of membrane technology which can be used to separate and concentrate macromolecular substances and small particles from a medium. A distinction is made between microfiltration, ultrafiltration and nanofiltration depending on the degree of separation. If the exclusion limit (or also “cut-off”) is 100 nm or more, then one talks of microfiltration. If the exclusion limit is in the range between 2-100 nm, this is then referred to as ultrafiltration. In the case of nanofiltration, the exclusion limit is below 2 nm. In each of these cases, they are purely physical, i.e. mechanical membrane separation processes which operate according to the principle of mechanical size exclusion: all particles in the fluids which are larger than the membrane pores are retained by the membrane. The driving force in both separation processes is the differential pressure between inflow and outflow from the filter area, which is between 0.1 and 40 bar.

The exclusion limits of ultrafiltration membranes are also given in the form of the NMWC (Nominal Molecular Weight Cut-Off, also MWCO, Molecular Weight Cut Off, unit: dalton). It is defined as the minimum molecular mass of globular molecules which are 90% retained by the membrane. In practice, the NMWC should be at least 20% lower than the molar mass of the molecule to be separated off. Further qualitative statements concerning the filtration can be made by reference to the flux (water value) (transmembrane flow or passage rate). In an ideal case, this is proportional to the transmembrane pressure and reciprocal to the membrane resistance. These parameters are determined both by the properties of the membrane used and also by concentration polarization and possible fouling which arises. The passage rate is based on 1 m² membrane area. Its unit is l/(m²h bar).

For the ultrafiltration, membranes have proven to be particularly suitable which have a pore diameter in the range from about 1000 to about 50 000 and preferably about 5000 to about 25 000 daltons. The nanofiltration prefers pore diameters in the range from 100 to 5000 and preferably about 500 to 2000 daltons.

The material of the filter area—both in the case of ultrafiltration and nanofiltration—can be stainless steel, polymer materials, ceramic, aluminium oxide or fabric. There are various manifestations of the filter elements: candle filters, flat membranes, spiral coil membranes, bag filters and hollow-fibre modules, which are all suitable in principle in the context of the present invention. However, preference is given to using spiral coil membranes made of polymer materials or candle filters made of ceramic or aluminium oxide, the first embodiment having proven to be particularly preferred for ultrafiltration and the second having proven to be particularly preferred for nanofiltration.

Both ultrafiltration and nanofiltration in the context of the present invention can be carried out “hot” or “cold”, i.e. in the temperature range from about 4 to about 55° C. However, it is preferred to work at temperatures in the low range from about 5 to about 20° C. (ultrafiltration) or 20 to 30° C. (nanofiltration).

Hydrolysis

The ultrafiltration serves to generate a lactose-containing and a lactose-free product stream. The former is then passed to a hydrolysis, while the latter is stored temporarily in a tank.

Lactose belongs to the group of disaccharides and consists of the two molecules D-galactose and D-glucose, which are connected via a β-1,4-glycosidic bond.

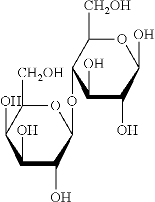

For the purposes of degradation into the two sugar components, lactose is treated with the enzyme lactase (also referred to as LPH or LCT). The hydrolysis preferably takes place in a stirred container with a continuous inflow and outflow, and also a metering device for the addition of the enzyme and a valve, situated at the bottom of the reactor, for discharging deactivated enzyme, which sediments over the course of time. It has proven to be advantageous to use an effective enzyme concentration of about 180 000 to 250 000 FCC units of lactase per kg of lactose to be hydrolysed, and to carry out the reaction at temperatures in the range from about 23 to about 27° C., and also a slightly acidic pH from about 5 to 6.

As described above, the reactor is connected to an NF unit, such that the total reaction mixture is continuously circulated over the membrane. Lactose-free solution is discharged via the permeate side and is then fed to the storage container and mixed with the retentate from the UF unit, whereas the retentate is returned to the reactor. In this way, enzyme is not lost; spent catalyst merely has to be fed either continuously or batchwise in order to ensure as uniform as possible an enzyme concentration. Inactive enzyme sinks to the bottom in the course of the process and can then be let out via a bottom valve while briefly interrupting the process.

### INDUSTRIAL APPLICABILITY

The invention further provides a device for producing lactose-free milk products comprising:
(a) an ultrafiltration unit UF,
(b) a storage and mixing container M,
(c) a stirred reactor R, and
(d) a nanofiltration unit NF,
where
(i) the retentate side of the UF unit is connected to the storage and mixing container and the permeate side is connected to the stirred reactor
(ii) the stirred reactor is connected to the NF unit, and
(iii) the permeate side of the NF unit is connected to the storage and mixing container and the retentate side is connected again to the stirred reactor in the form of a loop.

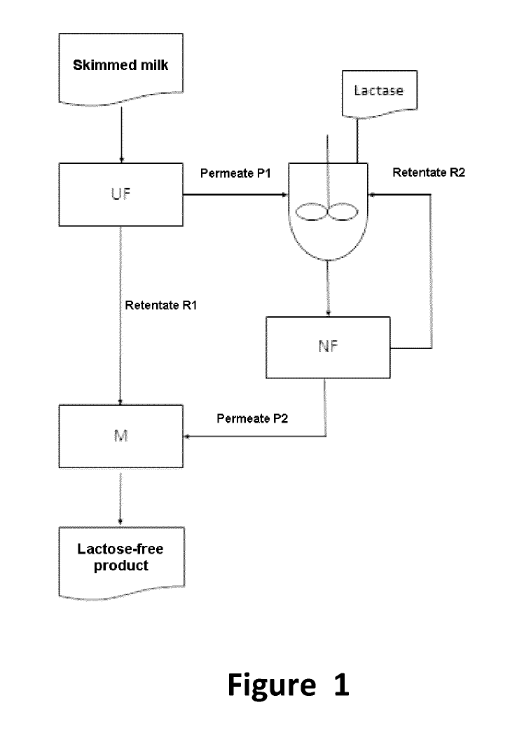

Process and device are explained in more detail below by FIG. 1. The reference numerals correspond to those used above.

### EXAMPLES

### Example 1

Skimmed milk was cooled to 15° C. and continuously passed at a rate of 100 l/h over a

UF pilot plant equipped with a spiral coil membrane (separation limit 20 000 daltons). The retentate R1 obtained here was fed to a collecting mixing container, whereas the lactose-containing permeate P1 was pumped into a continuously operated stirred reactor with a capacity of 100 l, where it was admixed with an amount of lactase such that a concentration of about 200 000 FCC units/kg lactose was reached. The mixture was adjusted to pH=6 and circulated at 25° C. over an NF pilot plant (ceramic membrane, separation limit 1000 daltons). Here, the lactose-free permeate P1 was fed to the mixing container and mixed with the retentate R1. The unreacted lactose and enzyme-containing retentate R2 was returned again to the enzyme reactor. The end product in the collecting container had a lactose concentration of less than 0.1% by weight and was free from enzymes and enzyme degradation products.

### Example 2

With a temperature of 30° C., skimmed milk was continuously passed at a rate of 120 l/h over a UF pilot plant equipped with a spiral coil membrane (separation limit 15 000 dalton). The retentate R1 obtained here was fed to a collecting mixing container, whereas the lactose-containing permeate P1 was pumped into a continuously operated stirred reactor with a capacity of 100 l, where it was admixed with an amount of lactase such that a concentration of about 200 000 FCC units/kg lactose was reached. The mixture was adjusted to pH=6 and circulated at 25° C. via an NF pilot plant (ceramic membrane, separation limit 500 daltons). Here, the lactose-free permeate P1 was fed to the mixing container and mixed with the retentate R1. The unreacted lactose and enzyme-containing retentate R2 was returned again to the enzyme reactor. The end product in the collecting container had a lactose concentration of less than 0.1% by weight and was free from enzymes and enzyme degradation products.

1. Process for producing lactose-free milk products, wherein
(a) skimmed milk is subjected to an ultrafiltration or to a combination of dia- and ultrafiltration,
(b) the lactose-free retentate R1 is fed to a storage container and the lactose-containing permeate P1 is fed to an enzyme reactor,
(c) an amount of lactase sufficient for the enzymatic degradation of the lactose present therein is added to the permeate P1,
(d) the reaction mixture obtained in this way is subjected to a nanofiltration,
(e) the lactose-free permeate P2 is conveyed to the storage container and mixed with the lactose-free retentate R2, and
(f) the retentate R2, which still comprises unreacted lactose and enzyme, is returned again to the enzyme reactor.

2. Process according to claim 1, carried out either continuously or discontinuously.

3. Process according to claim 1, wherein the ultrafiltration of the skimmed milk is performed by a membrane made of stainless steel, polymeric materials, ceramic, aluminium oxide or fabrics.

4. Process according to claim 1, wherein the ultrafiltration of the skimmed milk is carried out with membranes which have a pore diameter of about 1000 to 50 000 daltons.

5. Process according to claim 1, wherein the ultrafiltration of the skimmed milk is carried out at temperatures in the range from 4 to 55° C.

6. Process according to claim 1, wherein the hydrolysis is carried out at an enzyme concentration of from about 180 000 to 250 000 FCC units of lactase per kg of lactose to be reacted.

7. Process according to claim 1, wherein the hydrolysis is carried out at a temperature in the range from 23 to 27° C.

8. Process according to claim 1, wherein the hydrolysis is carried out at a pH in the range from 6 to 7.

9. Process according to claim 1, wherein the nanofiltration of the hydrolysis product is performed by a membrane made of stainless steel, polymer materials, ceramic, aluminium oxide or fabrics.

10. Process according to claim 1, wherein the nanofiltration of the hydrolysis product is carried out with membranes which have a pore diameter of from about 100 to 2000 daltons.

11. Process according to claim 1, wherein the nanofiltration of the hydrolysis product is carried out at temperatures in the range from 4 to 55° C.

12. Device for producing lactose-free milk products comprising:
(a) an ultrafiltration unit UF,
(b) a storage and mixing container M,
(c) a stirred reactor R, and
(d) a nanofiltration unit NF,
wherein
(i) the retentate side of the UF unit is connected to the storage and mixing container and the permeate side is connected to the stirred reactor,
(ii) the stirred reactor is connected to the NF unit, and
(iii) the permeate side of the NF unit is connected to the storage and mixing container and the retentate side is connected again to the stirred reactor in the form of a loop.
